(19) United States
(12) Patent Application Publication
(10) Pub. No.: US 2015/0235219 A1
(43) Pub. Date: Aug. 20, 2015

(54) ITEM/VALUE BASED RISK MITIGATING TRANSACTION AUTHORIZATION

(71) Applicant: Bank of America Corporation, Charlotte, NC (US)

(72) Inventors: Matthew D. Murphy, JR., Charlotte, NC (US); Jeffrey N. Healy, Matthews, NC (US); Steven M. Twombly, Saco, ME (US); Rosemary C. Stack, Wilmington, DE (US); Mark R. Wilson, Middletown, DE (US)

(73) Assignee: Bank of America Corporation, Charlotte, NC (US)

(21) Appl. No.: 14/184,574

(22) Filed: Feb. 19, 2014

(51) Int. Cl. G06Q 20/40

(52) U.S. Cl. CPC G06Q 20/4016

(57) ABSTRACT

Apparatus and methods for risk mitigating transaction authorization are provided. A transaction participant may responds to a request for transaction authorization with “PIN Entry Required,” and restrict signature based transaction authorizations. The risk mitigating transaction authorization may be transmitted for a transaction based on a stock-keeping-unit of an item included in a purchase. The risk mitigating transaction authorization may be transmitted for a transaction based on an amount of the transaction. The risk mitigating transaction authorization may be transmitted for a transaction based on a merchant category code identifier assigned to a merchant and/or a location of a purchase.

### FIELD OF TECHNOLOGY

Aspects of the disclosure relate to providing apparatus and methods for mitigating a risk of incurring a liability for a transaction between two or more transaction participants.

### BACKGROUND

A customer may purchase goods or services (“the product”) from a merchant by presenting a payment instrument. The payment instrument may allow the customer to draw on a line-of-credit. The line-of-credit may be extended to the customer by an issuing bank (the “issuer”) associated with the payment instrument. The payment instrument may allow the customer to submit a request to debit of an account of the customer held at a financial institution. The account of the customer may be maintained by the issuer.

The merchant may present the transaction to an acquiring bank (the “acquirer”). The acquirer may request authorization for the transaction from the issuer. The issuer may be provided an opportunity to authorize the transaction before extending credit to the customer or before accepting the request to debit the account of the customer. Typically, by providing authorization for the transaction, the issuer is agreeing to accept a post-authorization risk associated with the transaction. The post-authorization risk may include allegations of fraud or chargebacks. Typically, an issuer may decline to accept the post-authorization risk by denying the transaction in response to the authorization request.

The acquirer may request the authorization from the issuer by submitting the transaction to a transaction processing network. The transaction processing network may link the acquirer and the issuer. The transaction processing network may receive an authorization from the issuer and transmit the authorization to the acquirer. In response to receiving the authorization from the issuer, the merchant may release the product to the customer.

In response to receiving an authorization from the issuer (via the transaction processing network), the acquirer pays the merchant for (and thus “acquires”) the product. The transaction processing network may collect transaction processing network fees from the issuer and the acquirer in connection with a transaction settlement process. The transaction processing network in communication with the issuer and the acquirer may settle the transaction between the issuer and the acquirer.

Settling the transaction may include the transaction network receiving a plurality of transactions from the acquirer. Each transaction may be embodied in a transaction record. Each of the plurality of transaction records may comprise an amount authorized by the issuer. In response to receiving the transaction record, the transaction network may debit an account of the issuer. The debit may correspond to the amount authorized by the issuer. The transaction network may credit an account of the acquirer. The amount credited to the acquirer may correspond to the amount authorized.

A transaction settlement process may include a transfer of funds between two or more transaction participants. The transfer may be a “book transfer,” an inter-bank transfer or any suitable transfer between the transaction participants. A settlement network may transfer the funds between transaction participants. Illustrative settlement networks may include the Federal Reserve Wire Network (“Fedwire”) and other suitable settlement networks that are well known to those of ordinary skill in the art. The settlement network may include any suitable network linking one or more accounts of transaction participants.

A transaction participant may impose a transaction cost upon another transaction participant for participating in the transaction. The transaction cost may be referred to as “interchange.” Interchange may be a fixed fee for the transaction or a percentage of the transaction. Interchange may be a combination of a fixed fee and a percentage of the transaction.

Interchange typically flows from the acquirer, through the transaction processing network, to the issuer. For example, the issuer may transfer to the acquirer an amount net interchange. The issuer typically levies interchange to cover costs of acquiring credit/debit customers, servicing credit/debit accounts, providing incentives to retain customers, mitigating fraud, covering customer credit risk, group compensation, producing payment instruments and other expenses.

The acquirer may deduct a merchant discount from the amount that the acquirer pays the merchant in exchange for the product. The merchant discount may cover the acquirer's transaction processing network fee, interchange, and other expenses. The merchant discount may include a profit for the acquirer.

FIG. 1 shows typical transaction settlement flow 100. Flow 100 involves transaction participants such as the merchant, the customer, and transaction participants identified below. At step 1, the merchant provides $100 in product to the customer. To obtain the $100 in product, the customer may present a payment instrument. Presenting the payment instrument to the merchant may initiate a credit, debit or other electronic transaction. Presenting the payment instrument to the merchant may transfer information associated with the payment instrument to the merchant.

At step 2, the merchant submits a request for authorization to a transaction authorization and clearance provider. The transaction authorization and clearance provider may be an issuer of the payment instrument presented by the customer to initiate the transaction. The authorization request may be communicated to the transaction authorization and clearance provider by an acquirer of the merchant.

The transaction authorization and clearance provider may provide transaction authorization and clearance information to the merchant/acquirer. The transaction authorization information may be transferred from the issuer to the merchant via a transaction processing network. The transaction authorization and clearance information may include authorization for the transaction to proceed.

At step 3, the issuer transmits to the customer a statement showing the purchase price of $100.00 due. The issuer collects the purchase price amount, along with interest and fees if appropriate, from the customer. At step 4, the issuer routes the purchase price amount of $100.00 through the transaction processing network to the acquirer. At step 5, the acquirer partially reimburses the merchant for the purchase price amount. In the example shown in FIG. 1, the partial reimbursement is $98.00. The difference between the reimbursement amount $98.00 and the purchase price amount $100.00 is a two dollar $2.00 merchant discount.

At step 6, the acquirer pays a transaction cost $1.50, via the transaction processing network, to the issuer. At step 7, both the acquirer and the issuer pay a transaction cost ($0.07 for acquirer and $0.05 for the issuer) to the transaction processing network.

TABLE 1
Net positions, by participant, based on settlement
flow 100 (shown in FIG. 1).

| Participant | Net ($) |
|---|---|
| Issuer | 1.45 |
| Acquirer | 0.43 |
| Transaction processing network | 0.12 |
| Merchant | −2.00 |
| Customer | 0 |

In settlement flow 100 (shown in FIG. 1), the transaction cost is based on an exemplary merchant discount rate of 2%. The $1.50 interchange is based on an exemplary interchange rate of 1.5%. The sum of the transaction processing network fees ($0.07 and $0.05) is based on a total exemplary transaction processing network fee rate of 0.12%.

Transaction processing networks and transaction processing network services are offered under trademarks known to those of ordinary skill in the art. Transaction processing networks may set interchange rates. Issuers may set interchange rates. Interchange rates may vary for each transaction processing network. Interchange rates may vary based on merchant type and size, transaction processing method, transaction volume and other factors.

In a typical settlement flow, such as FIG. 1, after step 2, when the issuer provides authorization for the transaction, the issuer bears responsibility for any later arising charges or allegations of transaction fraud. For example, the customer may allege that, at step 1 the payment instrument information was fraudulently provided to the merchant. As a result of the allegation, the customer may refuse to pay one or more of the settlement, interest or fees depicted in step 3 of FIG. 1. Typically, the issuer bears a responsibility of investigating the allegation of fraud. A cost of investigating an allegation of transaction fraud may be $15-$20 per transaction.

The costs associated with transaction fraud may include evaluating merits of a claim of transaction fraud, identifying a source of a fraud, reimbursing the customer, waiving one or more fees charged to the customer or other suitable costs. At least a portion of the interchange may be utilized by the issuer to cover the cost of transaction fraud.

Interchange rates may be regulated. For example, a governmental agency such as the U.S. Treasury Department may issue regulations setting a maximum amount for an interchange fee. Interchange rates may be regulated for credit, debit or other electronic transactions. Regulation of interchange may limit a portion of interchange available for responding to transaction fraud.

It would be desirable, therefore, to provide apparatus and methods for mitigating a risk that a transaction may incur a post-authorization charge.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art scenario;

FIG. 2 shows an illustrative arrangement in accordance with the principles of the invention;

FIG. 3 shows an illustrative scenario in accordance with the principles of the invention;

FIG. 4 shows an illustrative scenario in accordance with the principles of the invention;

FIG. 5 shows an illustrative arrangement of apparatus in accordance with the principles of the invention;

FIG. 6 shows an illustrative arrangement of apparatus in accordance with the principles of the invention;

FIG. 7 shows an illustrative apparatus in accordance with the principles of the invention;

FIG. 8 shows an illustrative apparatus in accordance with the principles of the invention;

FIG. 9 shows an illustrative process in accordance with the principles of the invention;

FIG. 10 shows an illustrative process in accordance with the principles of the invention;

FIG. 11 shows an illustrative process in accordance with the principles of the invention;

FIG. 12 shows an illustrative process in accordance with the principles of the invention;

FIG. 13 shows an illustrative process in accordance with the principles of the invention; and

FIG. 14 shows an illustrative process in accordance with the principles of the invention.

### DETAILED DESCRIPTION OF THE INVENTION

Apparatus and methods for risk mitigating transaction authorization are provided. The risk may include a possibility of incurring a liability associated with the transaction. The liability may include cost associated with transaction fraud. Exemplary costs associated with transaction fraud are listed below in Table 2.

TABLE 2
Illustrative Costs of Transaction Fraud

Investigation allegations of fraud
Damage to corporate goodwill
Monetary compensation paid to settle fraud
claims
Delay in receiving payments due
Payments to acquirer/merchant
Payments to Transaction Processing Network
Invoicing costs for transaction services

The liability may include other suitable costs. The liability may include costs associated with the transaction that are incurred after the issuer has authorized the transaction (“post-authorization charge”). A post-authorization charge may include a chargeback cost.

A chargeback provides an issuer with a method of returning a transaction disputed by a customer. A chargeback situation may arise for reasons that include: a merchant failed to obtain an authorization, a transaction record that is altered, a transaction record that does not include a signature of the customer or a valid personal-identification-number (“PIN”), a merchant failed to obtain an imprint (electronic or manual) of a payment instrument presented by the customer and/or a merchant accepted an expired payment instrument.

When a chargeback right applies, the issuer sends the transaction back to the acquirer and “charges back” the dollar amount of the disputed purchase. The acquirer may then deduct the amount of the chargeback from the merchant's account. If there are no funds in the merchant's account to cover the chargeback amount, the acquirer may be obligated to cover a loss associated with the chargeback.

A merchant may re-present the chargeback to its acquirer. If the merchant cannot remedy the chargeback (i.e., by showing that an imprint of the payment instrument has been obtained), the merchant bears a loss associated with the chargeback.

The transaction may involve an acceptance of a payment instrument by a merchant. The transaction may be initiated by a customer presenting a payment instrument to make a purchase. The payment instrument may be a credit, debit, prepaid, stored value, gift, ATM, affinity, check, corporate, rewards, charge, prepaid, telephone, embossed, smart, magnetic stripe, bar code, transponder or radio frequency payment instrument or any suitable payment instrument available on the market.

The transaction may be a transaction in any state of completion. The transaction may be a prospective transaction. The prospective transaction may include a customer presenting the payment instrument to pay for the product. The prospective transaction may include the merchant collecting payment instrument information from the customer. Illustrative payment instrument informational items are shown below in table 3.

TABLE 3
Illustrative Payment Instrument Informational Items

Issuer
Transaction network
Customer name
Expiration date
Card security code (“CSC”)
Card verification data (“CVD”)
Card verification value (“CVV,”“CVV2,” “iCVV” or “Dynamic CVV”)
Card verification value code (“CVVC”)
Card verification code (“CVC” or “CVC2”)
Verification code (“V-code”)
Card code verification (“CCV”)
Signature panel code (“SPC”)
Customer identification number (“CID”)
Card account number
Brand
Card present transaction
Card not present transaction
Data storage (i.e., magnetic strip, smartphone, smart card ect . . . )
Affinity

The transaction may be a pending transaction. For example, a transaction may be pending prior to receiving authorization from the issuer. The transaction may be pending during a time between receiving the authorization and settlement. The transaction may be pending during a time prior to collection, by the issuer, of the purchase amount from the customer.

The transaction may be an executed transaction. Executing the transaction may include a first transaction participant passing the transaction or a transaction record along to a second transaction participant. An executed transaction may include a transaction that has been authorized and/or settled.

A risk of incurring a liability may be allocated among one or more transaction participants. Table 4 shows illustrative transaction participant types.

TABLE 4
Illustrative Transaction Participant Types

Merchant
Customer
Authorization service provider
Clearance service provider
Settlement service provider
Issuer
Transaction processing network
Acquirer
Transaction broker

More than one participant of a given type may be available to participate in the transaction. Different participants of the same type may have advantages and/or disadvantages relative to the other participants of that type. For example, one issuer may be a member of a lending consortium while another participant is not a member, one transaction processing network may require payment of a relatively small interchange fee while another network may require payment of a relatively large interchange fee, and the like.

The payment instrument used to initiate the transaction may include a credit card, debit card and/or other suitable payment instruments. Such other payment instruments may include: cash, a check, an instrument or device that includes a contactless chip, such as an ISO14443-compliant contactless chip, a smart phone, a tablet computer, a transponder or any other suitable electronic purchasing devices. Payment instruments may store data in a magnetic strip, a bar code, a silicon chip, non-volatile computer readable media or any other suitable data storage device or format.

The payment instrument may be presented to the merchant by the customer as payment for the product. The merchant may provide a point-of-sale (“POS”) terminal that is configured to receive data from, provide data to, or exchange data with the payment instrument.

The transaction may be associated with one or more transaction attributes. A transaction record may be generated based on transaction attributes received and/or available at a time the transaction is initiated. Each transaction record may include one or more fields. Each field may store an attribute of the transaction. A transaction record may include one or more fields storing information associated with an attribute. Table 5 shows illustrative transaction attributes and illustrative information associated with each attribute.

TABLE 5

| Illustrative Transaction | Illustrative Associated |
|---|---|
| Attributes | Information |
| Geographic | Longitude/latitude |
| | GPS coordinates |
| | Map coordinates |
| | Elevation |
| | Depth |
| | Distance from a point |
| | Address |
| | Zip code |
| | Area code |
| | County |
| | State |
| | Country |
| | IP address |
| | Signal triangulation |
| Temporal | Seconds |
| | Minutes |
| | Hours |
| | Day |
| | Week |
| | Month |
| | Year |
| | Duration |
| Synoptic | Weather at time of |
| | transaction |
| | Stock market performance at |
| | time of transaction |
| | Political party in power at |
| | time of transaction |
| | Transaction participant risk |
| Transaction | Dollars |
| | Available credit |
| | Currency |
| | Foreign exchange rate |
| | Card present |
| | Card not present |
| Number of items purchased | Number |
| | Number of distinct stock |
| | keeping units (“SKU”) |
| | Cost/Value of item |
| Merchant category code | Numerical identifier |
| | Taxation status |
| | Associated acquirer |
| Payment instrument | Type (i.e., credit, debit, |
| | rewards ect . . . ) |
| | Data storage (i.e., magnetic |
| | strip, smartphone, smart card |
| | ect . . . ) |
| | Brand |
| | Transaction Network |
| | Issuer |
| | Acquirer |
| | Affinity |
| Loyalty program | Rewards/point balance |
| | Membership level |
| | Duration of membership |
| | Frequency of use |
| Access Channel | Point-of-sale |
| | Automated teller machine |
| | Online portal |
| | Self-service kiosk |
| | Mobile device |
| | In person |

A transaction attribute may be a synoptic attribute. The synoptic attribute may be derived by grouping individual transaction records that share one or more attributes. For example, transaction records may be grouped based on a common surcharge. Transaction records may be grouped based on date, merchant category code (“MCC”), number of items purchased or a credit card identifier.

### Risk Mitigating Transaction Authorization

Apparatus may include, and methods may involve, a computer that is configured to dynamically select an authorization method for a transaction. The transaction may be a debit transaction. The transaction may be initiated at a POS using a payment instrument. The computer may include a non-transitory computer readable medium having computer readable program code embodied therein. The computer may include a processor. The processor may execute the computer readable program code (“code”). The code, when executed by the processor, may instruct the computer to perform one or more tasks.

The code may determine a level of risk associated with the debit transaction. The risk may correspond to a risk of the debit transaction being associated with a post-authorization charge. The level of risk may be determined based on conducting an analysis of historical transaction records. The analysis of the historical transaction records may identify patterns indicating that a current debit transaction has one or more attributes in common with historical transactions that incurred a post-authorization charge.

The code may select an authorization method corresponding to the level of risk. For example, if the debit transaction is associated with a level of risk above a threshold level, an authorization method for the transaction may require a different quantity or quality of information than if the level of risk was below the threshold level.

The code may transmit the selected authorization method to a transaction participant and/or the POS. Illustrative information that may be requested by a selected authorization method is shown below in table 6. The information may be requested by a transaction participant to reduce a risk of authorizing a transaction that may incur a post-authorization charge. Any suitable combination of the information in table 6 may be requested.

TABLE 6
Illustrative Informational Items Requested By A Transaction Participant

Use designated transaction processing network
Require PIN entry
Display photo ID
Scan barcode on photo ID
Swipe a second payment instrument (for verification purposes only)
Enter billing zip code
Enter billing phone number
Enter billing address street number
Enter birthdate
Enter expiration date associated with payment instrument
Enter portion of card number (i.e., last four digits, entire number)
Respond to text message from transaction participant
Require merchant to transmit transaction “batch” within 24 hours of
authorization

In response to receiving information required by the selected authorization method, the code may associate the debit transaction with a payment guarantee. The payment guarantee may be provided by an issuer of the payment instrument or any suitable transaction participant. In response to receiving information required by the selected authorization, the code may authorize the debit transaction. In some embodiments, the code may submit an authorization request for the debit transaction to a transaction processing network.

In response to a failure to receive the required information, the code may require a signature to authorize the debit transaction. The code may authorize the debit transaction in response to receiving the signature. However, the code may not associate the payment guarantee with the debit transaction if the required information responsive to the selected authorization method is not provided.

The selected authorization method may include code that when executed by the processor requires a customer that initiated the debit transaction to enter a personal-identification-number (“PIN”) associated with the payment instrument. Knowledge of the PIN may not be available to an imposter who fraudulently initiates a transaction. Entry of the PIN may mitigate a risk that the debit transaction may incur a post-authorization charge.

The selected authorization method may include code that, when executed by the processor, requires verification of a relationship between the customer and the presented payment instrument. Verification of the relationship may mitigate a risk that the debit transaction incurs a post-authorization charge. Verification of the relationship may mitigate the risk by obtaining information that demonstrates that the customer presenting the payment instrument is a lawful possessor of the payment instrument and/or payment instrument information.

The selected authorization method may include code that when executed by the processor requires verification of a characteristic of the payment instrument. Verification of the characteristic may mitigate a risk that the debit transaction incurs a post-authorization charge. Verification of the characteristic may mitigate the risk by obtaining information that demonstrates that the payment instrument and/or payment instrument information has been lawfully manufactured.

Fraudulently produced payment instruments may include discrepancies in information encoded in a magnetic strip of the payment instrument and information printed on a face of the payment instrument. Detection of the discrepancy may correspond to detection of a fraudulent transaction.

The code, when executed by the processor, may require that the characteristic correspond to information displayed on the payment instrument and/or a zip code associated with the payment instrument.

A transaction participant may reject a selected authorization method. For example, a transaction processing network may refuse to communicate the selected authorization method and/or information responsive to the selected authorization method. As a further example, the merchant may not wish to inconvenience the customer by requesting that the customer provide the required information. In response to a rejection of the selected authorization method, the code, when executed by the processor, may deny the debit transaction.

In some embodiments, in response to a rejection of the selected authorization method, the code may accept a signature to authorize the transaction and may not associate the transaction with a payment guarantee. Typically, an issuer may guarantee that, after the issuer provides an authorization for the transaction, a post-authorization charge received after authorizing a transaction will not reduce or otherwise impact an amount of funds transferred from the issuer to the merchant, acquirer and/or other transaction participant. However, the issuer may be unwilling to provide the payment guarantee without mitigating a risk that the post-authorization charge will be incurred.

A selected authorization method may be a first authorization method. In response to a rejection of the first authorization method, the code, when executed by the processor, may select a second authorization method. In response to a rejection of the first authorization method, the code when executed by the processor may transmit the second authorization method to the point-of-sale, merchant and/or other transaction participant.

A payment guarantee may be a first payment guarantee. In response to receiving information required by a second selected authorization method, the code, when executed by the processor, may associate the debit transaction with a second payment guarantee. The second payment guarantee may be provided by a first transaction participant to a second transaction participant. The first transaction participant may be an issuer. An amount guaranteed by the second payment guarantee may be less than an amount of the debit transaction. An amount guaranteed by the second payment guarantee may be less than an amount guaranteed by the first payment guarantee.

The selected authorization method may include code that when executed by the processor requires capturing, at a POS, a barcode displayed on a photo identification of the customer. The selected authorization method may include code that when executed by the processor requires transmitting the barcode from the POS to an issuer associated with the payment instrument.

Based on information included in the barcode, the issuer or other suitable transaction participant may assess a validity of the transaction. For example, the issuer may verify that a name on the photo identification matches a name associated with the payment instrument used to initiate the transaction.

The selected authorization method may include code that when executed by the processor requires confirmation that a name displayed on a photo identification of the customer corresponds to a name displayed on the payment instrument. In some embodiments, the merchant may transmit a confirmation of the correspondence to another transaction participant. The confirmation may be transmitted from a POS.

The code when executed by the processor may receive a proposed change to a selected authorization method. The proposed change may be submitted by any suitable transaction participant. For example, a merchant may decide not to inconvenience a customer by requesting information required by a selected authorization method. The merchant decision may be based on a transaction attribute in the transaction record. For example, the purchase may be a low-value purchase. The code may not register the proposed change as a failure to respond with information required by the selected authorization method.

The code, when executed by the processor, may deny the debit transaction when, for a plurality of debit transactions, a proposed change increases an aggregate dollar amount of risk accepted by a transaction participant above a threshold level.

For example, a proposed change may shift risk associated with the transaction to an issuer. The issuer may be required to make an APPROVE or DENY authorization decision without information responsive to the selected authorization method.

In some embodiments, a transaction participant may accept less than full compliance with a selected authorization method. For example, an issuer may accept less than full compliance for a threshold number of transactions. After the threshold number is exceeded, the issuer may deny a transaction in response to a proposed change that proposes less than full compliance with a selected authorization method for the transaction. A transaction participant may decide to accept less than full compliance based on one of more transaction attributes. Less than full compliance may include no information responsive to a selected authorization method.

An aggregate dollar amount of risk may include a cost to investigate claims alleging that a number of a plurality of debit transactions that may be fraudulent. An aggregate dollar amount of risk may include a cost associated with chargebacks associated with a plurality of debit transactions. Each of the plurality of debit transactions may share a common transaction attribute.

Apparatus may include, and methods may involve, one or more non-transitory computer-readable media storing computer-executable instructions which, when executed by a processor on a computer system, perform a method of dynamically selecting an authorization method for a transaction. The transaction may be a debit transaction or any suitable transaction.

The method may include receiving a request from a customer to initiate a debit transaction as payment for a purchase. The method may include determining a fraud investigation risk associated with the debit transaction. The fraud investigation risk may include a risk that the debit transaction may be subject to a fraud investigation. The fraud investigation risk may be determined based on comparing or correlating one or more transaction attributes of the debit transaction to historical transaction records.

In response to determining that the fraud investigation risk exceeds a threshold risk level, the method may include requiring that the customer enter a PIN associated with the payment instrument. Customer entry of a correct PIN may decrease the fraud investigation risk to a level below the threshold. Typically, only a legitimate possessor of the payment instrument has knowledge of the PIN. The method may include only authorizing the debit transaction in response to receiving the PIN. A signature may not be accepted to authorize a transaction associated with the fraud investigation risk.

In response to determining that the fraud investigation risk does not exceed the threshold risk level, the method may include requiring that the customer provide a signature. The method may include authorizing the debit transaction based on the signature only when the fraud investigation risk does not exceed the threshold.

In response to determining that a fraud investigation risk exceeds a threshold risk level, the method may include denying the transaction if a correct PIN is not received. A correct PIN is a PIN properly associated with the payment instrument. For example, an issuer may deem a transaction “too risky” unless a PIN is successfully entered.

A fraud investigation risk may include a risk of receiving a chargeback of the transaction. A transaction participant may be charged a fee by an issuer or other transaction participant if the PIN is not provided and the transaction is charged back.

The purchase may be a first purchase. The customer may be a first customer. The method may include receiving a request from a second customer to initiate a credit transaction as payment for a second purchase. The method may include requiring that the second customer provide a signature. The second customer may not be required to provide additional verification information. A fraud investigation risk for the credit transaction may not be determined. An interchange fee associated with the credit transaction may be sufficient to cover a risk of possible losses resulting from a post-authorization charge. The method may include authorizing the credit transaction based on a signature without determining a fraud investigation risk for the credit transaction.

Apparatus may include and methods may involve an article of manufacture comprising a computer usable medium having computer readable program code embodied therein. The article may authorize a transaction initiated using a payment instrument.

The code in the article of manufacture, when executed by a processor, may determine whether a transaction is a credit transaction or a debit transaction. When the transaction is a debit transaction, the code may determine whether the debit transaction is associated with a threshold risk of incurring a post-authorization cost or charge. When the debit transaction is associated with the threshold risk, the code may only authorize the debit transaction in response to receiving a PIN associated with the payment instrument.

When the transaction is a credit transaction, the code may authorize the credit transaction in response to receiving a PIN associated with the payment instrument or a signature.

The code when executed by the processor may deny the debit transaction in response to a failure to receive the PIN. The failure may be registered if the information is not received within a pre-determined time window.

### Item/Value Based Risk Mitigating Transaction Authorization

Apparatus may include, and methods may involve, a computer that is configured to dynamically select an authorization method for a transaction. The transaction may be a debit transaction or any suitable transaction. The transaction may be initiated by a customer at a POS using a payment instrument. A POS may include a POS terminal.

The computer may include a non-transitory computer readable medium having computer readable program code embodied therein. The computer may include a processor configured to execute the computer readable program code.

The code when executed by the processor may request a stock-keeping-unit (“SKU”) of an item. The SKU may be captured by a scanner at the POS. The SKU may be associated with a level of risk that the transaction may incur a post-authorization charge. For example, SKUs corresponding to high demand or popular items may be associated with a higher incidence of fraudulent attempts to obtain the items.

The code may identify a payment instrument as a debit card. The code may determine, based on the SKU, a level of risk associated with the debit transaction. The code may select an authorization method based on the level of risk. For example, the higher the level of risk, the more information may be requested by the authorization method. The additional information may expose imposters who do not have legitimate access to the requested information.

The code may transmit the selected authorization method to a POS. The customer may be required to provide the requested information at the POS. The customer may be required to provide the requested information at the POS after an amount charged for goods purchased at the POS is known.

In response to receiving information required by a selected authorization method, the code may associate the debit transaction with a payment guarantee. The payment guarantee may be provided by any suitable transaction participant such as an issuer of the payment instrument. The payment guarantee may be provided by a consortium of transaction participants. The consortium may be formed to reduce fraud associated with transactions. In response to a failure to receive information required by the selected authorization method, the debit transaction may not be associated with a payment guarantee.

A selected authorization method may include code, that when executed by the processor, requires that a customer enter a PIN linked to the payment instrument to authorize the debit transaction. The code may prevent the customer from signing at the POS to authorize the debit transaction. A selected authorization may require that a transaction participant obtain any suitable information listed above in table 6.

The selected authorization method may include code that when executed by the processor requires verification of a relationship between the customer and the payment instrument. The code may require that the merchant or other suitable transaction participant conduct the verification. The code may require that the merchant confirm that the verification was conducted.

For example, an authorization method may require that the customer enter the last four digit of a number displayed on a payment instrument. The digits entered by the customer may be transmitted to an issuer of the payment instrument. The issuer may verify the four digits entered by the customer correspond to four digits of the number included in a transaction record. In some instances of fraud, a number displayed on the face of the payment instrument differs from a number encoded on a magnetic strip of the payment instrument.

The code when executed by the processor, in response to a rejection of the selected authorization method, may deny the debit transaction. The code may deny the debit transaction based on the level of risk associated with the debit transaction.

The code when executed by the processor may receive a proposed change to the selected authorization method transmitted to the issuer. The code when executed by the processor may deny a debit transaction when, for a plurality of debit transactions, the proposed change increases an aggregate dollar amount of risk above a threshold dollar amount. The aggregate risk may be determined based on transactions that are with the SKU. The aggregate risk may be determined based on a number of proposed changes that have been requested and/or accepted.

The aggregate dollar amount of risk may include a risk that an issuer of the payment instrument will receive a threshold number of claims alleging that a number of the plurality of debit transactions associated with the SKU are fraudulent. The aggregate dollar amount of risk may include a cost of chargebacks submitted to an issuer of the payment instrument for a plurality of debit transactions associated with the SKU.

Apparatus may include, and methods may involve, one or more non-transitory computer-readable media storing computer-executable instructions. The instructions, when executed by a processor on a computer system, may perform a method of dynamically selecting an authorization method for a debit transaction.

The method may include receiving a request from a customer to initiate a debit transaction as payment for a purchase. The method may include determining a fraud investigation risk associated with the debit transaction. In response to determining that a fraud investigation risk exceeds a threshold risk level, the method may include requiring that the customer enter a PIN associated with the payment instrument. The method may include only authorizing the debit transaction based on the PIN.

In response to determining that the fraud investigation risk does not exceed the threshold risk level, the method may include requiring that the customer provide a signature and authorizing the debit transaction based on the signature. The fraud investigation risk may include a risk that the debit transaction will be associated with a chargeback.

The method may be implemented by execution of the code. The method may be performed within one second from a time the debit transaction is initiated. The transaction may be denied if the PIN if not received within a pre-determined timeframe.

The purchase may be a first purchase and the customer may be a first customer. The method may include receiving a request from a second customer to initiate a credit transaction as payment for a second purchase. The method may include requiring that the second customer provide a signature and authorizing the credit transaction based on the signature without determining the fraud investigation risk associated with the credit transaction.

Apparatus may include, and methods may involve, an article of manufacture comprising a computer usable medium having computer readable program code embodied therein. The code when executed by a processor may authorize a transaction initiated using a payment instrument.

The code may determine whether the transaction is a credit transaction or a debit transaction. When the transaction is the debit transaction, he code may determine whether the debit transaction is associated with a threshold risk of incurring a post-authorization cost. When the debit transaction is associated with the threshold risk, the code may only initiate an authorization process for the debit transaction in response to receiving a PIN associated with the payment instrument.

When the transaction is a credit transaction, the code may authorize the credit transaction in response to receiving a PIN associated with the payment instrument or a customer signature. The code when executed by the processor may deny the debit transaction in response to a failure to receive the requested PIN.

A risk allocation flag may be associated with a transaction based on performance metric. The performance metric may be determined based on transaction attributes of one or more transactions. The performance metric may be determined based on one or more transactions associated with a transaction participant. For example, the performance metric may be determined based on transactions corresponding to purchases from a merchant. The performance metric may be any suitable performance metric. Table 7 lists illustrative performance metrics.

TABLE 7
Illustrative Performance Metrics

Transaction volume (number)
Transaction volume ($)
Transaction frequency (per item)
Transaction frequency (per sale)
Total sales
Sales per fiscal period
Number of credit card purchases
Number of non-credit card purchases
Number of items purchased
Cost/price per item purchased
Same store sales
Number of transactions authorized per
instrument product type
Number of transaction denied
Interchange revenue per transaction
Interchange revenue per merchant
Interchange revenue per payment instrument
Daily interchange revenue
Number of chargebacks
Number of customer inquiries regarding
transaction participant behavior
Number of fraud investigations associated
with transaction attribute(s)
Number of customer complaints regarding
transaction participant behavior

### Location Based Risk Mitigating Transaction Authorization

Apparatus may include, and methods may involve, a computer that is configured to dynamically select an authorization method for a transaction. The transaction may be a debit transaction or any suitable transaction. The transaction may be initiated by a customer at a POS using a payment instrument. The computer may include a non-transitory computer readable medium having computer readable program code embodied therein. The computer may include a processor configured to execute the computer readable program code.

The code when executed by the processor may identify the payment instrument as a debit card. The code may identify a location of the POS. The location may be a geographic location. The location may correspond to a geographic transaction attribute shown above in table 5.

The code may determine, based on the location, a level of risk associated with the debit transaction. For example, a location may be associated with a relatively higher risk of incurring a post-authorization charge than other locations. The location may be associated with a relatively higher risk as a result of demographics, socio-economic conditions or other suitable factors in a vicinity of the location.

The code may select an authorization method based on the level of risk. The code may transmit the selected authorization method to a transaction participant. The transaction participant may be a merchant. The selected authorization method may be presented at the POS. The POS may include a POS terminal.

In response to receiving information required by a selected authorization, the code may associate the debit transaction with a payment guarantee. In response to a failure to receive the required information, the code may not associate the debit transaction with the payment guarantee.

The code may calculate a risk score for the location. The risk score may be calculated based on a historical record of debit transactions initiated at the location. The code may update the score in response to each debit transaction conducted at the location. The code may determine a level of risk associated with the debit transaction based on the risk score.

The code, when executed by the processor, may determine a location based on a merchant category code (“MCC”) associated with a POS.

A MCC may classify a transaction participant based on a primary line of business. For example, a merchant may be assigned a MCC based on whether the merchant provides predominately goods or provides predominately services. If a merchant provides both goods and services, a MCC assigned to the merchant may correspond to the greater portion of the merchant's business.

A MCC may classify a transaction participant based on a market segment serviced by the merchant. A MCC may be associated with a taxation status. Exemplary MCCs and associated market segments are shown below in Table 8.

TABLE 8

| Illustrative Merchant Category Code | Illustrative Associated Market |
|---|---|
| (“MCC”) | Segment |
| 0742 | Veterinary Services |
| 4214 | Motor Freight Carriers and |
| | Trucking - Local and Long |
| | Distance, Moving and Storage |
| | Companies, and Local Delivery |
| | Services |
| 4812 | Telecommunication Equipment and |
| | Telephone Sales |
| 5047 | Medical, Dental, Ophthalmic, |
| | and Hospital Equipment and |
| | Supplies |
| 5172 | Petroleum and Petroleum |
| | Products |
| 5718 | Fireplace, Fireplace Screens, |
| | and Accessories Stores |

A MCC may be assigned by an acquirer. The acquirer may assign the MCC to a merchant at a time the merchant agrees to accept a payment instrument as a form of payment.

A merchant may be assigned multiple MCCs. For example, the merchant may provide pharmacy products and grocery products. The pharmacy products may be assigned a first MCC and the grocery products may be assigned a second MCC.

The MCC may be a transaction attribute. For example, the merchant may provide predominately pharmacy products at a first location and predominately grocery products at a second location. A transaction that occurs at the first location may be associated with the first MCC. A transaction that occurs at the second location may be associated with the second MCC.

As a further example, the merchant may house a pharmacy and a grocery at a single address. The pharmacy may be associated with a first POS location and the grocery may be associated with a second POS location. Purchases made at the first POS location may be associated with the first MCC and purchases made at the second POS location may be associated with the second MCC.

The code when executed by the processor may determine the level of risk based on comparing a billing address associated with the payment instrument to a geographic location of the POS. If a difference between the billing address and location of the POS is greater than a threshold distance, the transaction may be associated with a heightened risk of fraud or other post-authorization charges.

The code when executed by the processor may identify a failure to receive information requested by the selected authorization method when the information is not received by the computer within a pre-determined timeframe. The pre-determined timeframe may be calculated based on a time that the debit transaction is initiated. The timeframe may be one minute or less.

The selected authorization method may include code that when executed by the processor may require the customer to enter, at the POS, a PIN associated with the payment instrument. The selected authorization methods may not allow the customer to sign at the POS to authorize the debit transaction. The selected authorization may require submission of any suitable informational items or combination of informational items listed above in table 6.

The code when executed by the processor may receive a rejection of the selected authorization method and in response to the rejection, deny the debit transaction. For example, an issuer may assess that a transaction is too risky unless the selected authorization method is followed by the merchant. If the merchant objects to implementing the selected authorization methods, the issuer may deny the transaction.

The selected authorization method may be a first selected authorization method. In response to a rejection of the first selected authorization method, the code when executed by the processor may select a second authorization method based on the level of risk. The code may transmit the second selected authorization method to the merchant. The code may transmit the second selected authorization method to the point-of-sale.

For example, an issuer may request that to authorize a transaction, a first selected authorization method be implemented. If the merchant implements the first selected authorization method, the issuer may bear 100% of a risk that the transaction may be associated with a post-authorization charge. The merchant may object to implementing the first selected authorization method. The issuer may respond to the rejection with a second selected authorization method. The second selected authorization method may request less information than the first selected authorization method. If the merchant implements the second selected authorization method, the issuer may only bear 75% of the risk. Another transaction participant, such as the acquirer may bear the remaining 25% of the risk.

The code when executed by the processor may deny the debit transaction. The code may deny the debit transaction when, for a plurality of debit transactions initiated at the location, a proposed change to the selected authorization method submits by a transaction participant increases an aggregate amount of risk originating from the location. The code may deny the debit transaction when the proposed change increases an aggregate dollar amount of risk originating from the location and accepted by the issuer, above a threshold amount of risk borne by the issuer.

The aggregate dollar amount of risk may be determined based on a risk of a transaction participant receiving a threshold number of claims alleging that debit transactions initiated at the location are fraudulent. The aggregate amount of risk may include a risk that a transaction participant may receive a threshold number of chargebacks for transactions initiated at the location.

Apparatus may include, and methods may involve, one or more non-transitory computer-readable media storing computer-executable instructions which, when executed by a processor on a computer system, perform a method of dynamically selecting an authorization method for a debit transaction. The method may include receiving a request from a customer to initiate the debit transaction as payment for a purchase at a location. The method may include determining, for the location, a fraud investigation risk associated with the debit transaction.

In response to determining that the fraud investigation risk exceeds a threshold risk level, the method may include requiring that the customer enter a PIN associated with the payment instrument and only authorizing the debit transaction based on the PIN.

In response to determining that the fraud investigation risk does not exceed the threshold risk level, the method may include requiring that the customer provide a signature and authorizing the debit transaction based on the signature. The method may be performed within one second from a time the debit transaction is initiated.

The purchase may a first purchase at the location. The customer may be a first customer. The method may include receiving a request from a second customer to initiate a credit transaction as payment for a second purchase at the location. The method may include requiring that the second customer provide a signature. The method may include authorizing the credit transaction based on the signature without determining the fraud investigation risk for the credit transaction.

Apparatus may include, and methods may involve, an article of manufacture comprising a computer usable medium having computer readable program code embodied therein for authorizing a transaction initiated using a payment instrument.

The code, when executed by the processor may determine whether the transaction is a credit transaction or a debit transaction. When the transaction is a debit transaction, the code may identify a location where the debit transaction is initiated. The code may determine whether the location is associated with a threshold risk of incurring a post-authorization cost for the debit transaction. When the location is associated with the threshold risk, the code may only authorize the debit transaction in response to receiving a PIN associated with the payment instrument.

When the transaction is a credit transaction, the code may authorize the credit transaction in response to receiving a PIN associated with the payment instrument or a signature.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

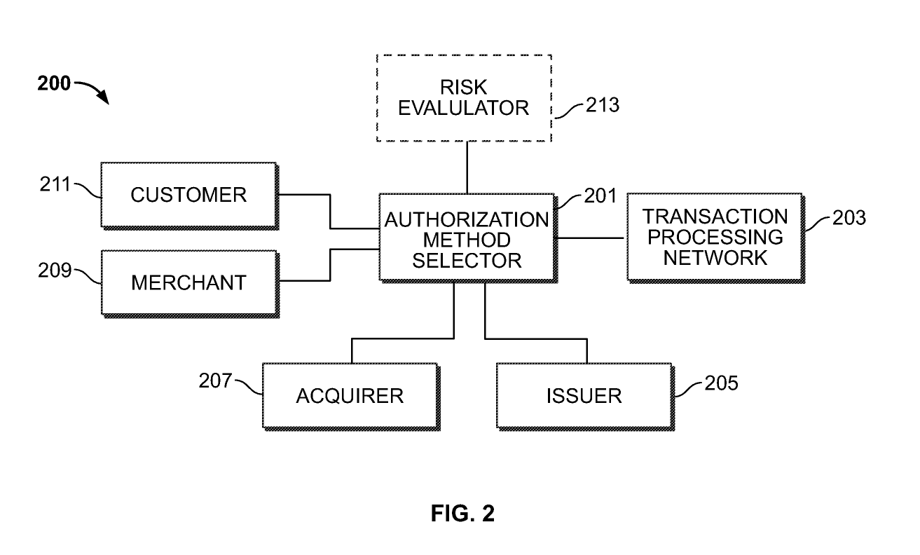

FIG. 2 shows illustrative arrangement 200. Arrangement 300 shows transaction participants in communication with authorization method selector (“AMS”) 201. AMS 201 may select an authorization method for a transaction. AMS 201 may communicate with one or more transaction participants. AMS 201 may communicate with transaction processing network 203, issuer 205, acquirer 207, merchant 209 and/or customer 211. AMS 201 may receive transaction records from a transaction participant.

An authorization method selected by AMS 201 may require that a transaction participant provide information responsive to the selected method. For example, AMS 201 may require that customer 211 enter a PIN at a POS before submitting the transaction to issuer 205 for authorization.

AMS 201 may communicate with risk evaluator (“RE”) 213. In some embodiments (not shown) AMS 201 may include RE 213.

RE 213 may evaluate a risk that a transaction received by AMS 201 may incur a post-authorization charge. AMS 201 may select an authorization method based on a level of risk determined by RE 213. The selected authorization method may reduce a risk that the transaction incurs a post-authorization charge.

AMS 201 may select an authorization method based on an allocation of the risk associated with a transaction among transaction participants. For example, two or more transaction participant may share a risk that a transaction may incur a post-authorization charge.

AMS 201 may transmit one or more transaction attributes to RE 213. In some embodiments, AMS 201 may submit a query for information in possession of a transaction participant such as issuer 205 or transaction processing network 203. In some embodiments, AMS 201 and/or RE 213 may be operated by a transaction participant such as issuer 205.

For example, issuer 205 may possess historical transaction records that include transaction attributes shared with the transaction record received from merchant 209. Based on information obtained from issuer 205, RE 213 may assign a risk to a transaction received from merchant 209. Based on the risk, AMS 201 may select an authorization method for the transaction.

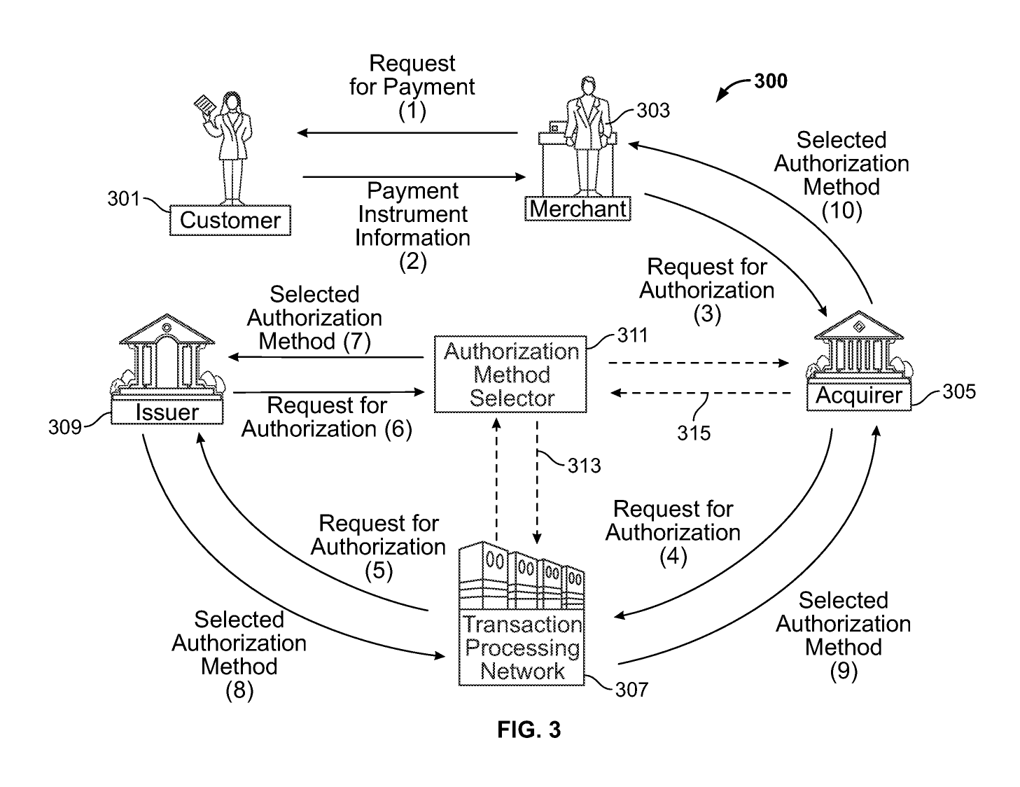

FIG. 3A shows illustrative information flow 300. At step 1, merchant 303 requests that customer 301 remit a payment for goods purchased from merchant 303. At step 2, customer 301 may present a payment instrument to initiate a transaction. Presenting the payment instrument may include swiping the payment instrument or otherwise transferring payment instrument information to merchant 303.

At step 3, merchant 303 requests authorization for the transaction from acquirer 305. At step 4, acquirer 305 transmits an authorization request to transaction processing network 307. At step 5, transaction processing network 307 identifies issuer 309 associated with the payment instrument presented by customer 301. At step 5, transaction processing network 307 requests that issuer 309 authorize or deny the transaction.

At step 6, in response to receiving the authorization request from transaction processing network 307, issuer 309 submits the authorization request to authorization method selector (“AMS”) 311. An authorization request received by issuer 309 may include a transaction record or transaction attributes. Merchant 303, acquirer 305 and transaction processing network 307 may communicate one or more transaction attributes requested by issuer 309 and/or AMS 311.

Based on the received transaction attributes, AMS 311 may select an authorization method for the transaction. AMS 311 may select an authorization method based on an evaluation of a risk that the transaction may incur a post-authorization charge.

At step 7, AMS 311 responds to issuer 309 with a selected authorization method. The selected authorization method may require that merchant 303 obtain additional information from customer 301 before issuer 309 authorizes the transaction. Illustrative information that may be requested from customer 301 is shown above in table 6. The selected authorization method may inform transaction processing network 307, acquirer 305, merchant 303 and/or customer 301 that issuer 309 will not bear 100% of any post-authorization charges associated with the transaction.

At step 8, the selected authorization method is transmitted from issuer 309 to transaction processing network 307. At step 9, transaction processing network transmits the selected authorization method to acquirer 305. At step 10, acquirer 305 informs merchant 303 of the requirements imposed by the selected authorization method received from issuer 309.

Communication lines 313 show that in some embodiments, AMS 311 may communicate directly with transaction processing network 307. Communication lines 315 show that in some embodiments, AMS 311 may communicate directly with acquirer 305. AMS 311 may communicate directly with any other transaction participants, such as customer 301 and merchant 303 (not shown).

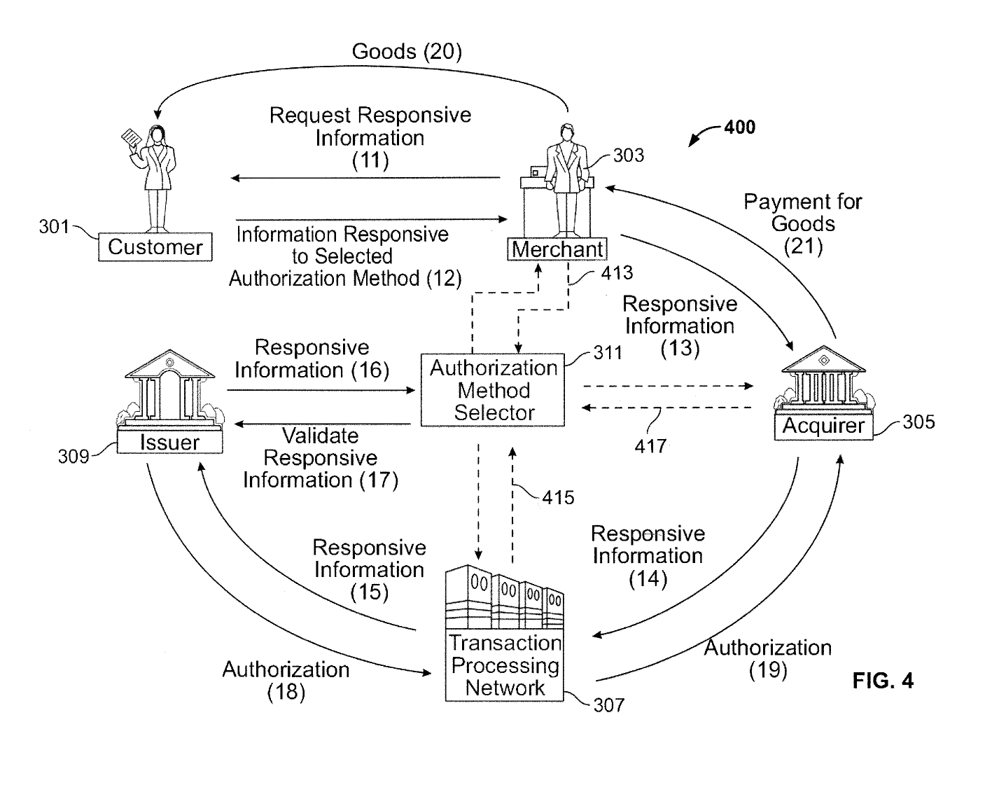

FIG. 4 shows illustrative information flow 400. Flow 400 continues following step 10 in FIG. 3. At step 11 in flow 400, merchant 303 requests that customer 301 provide information responsive to the authorization method selected by AMS 311. Illustrative information that may be requested from customer 301 is shown above in table 6.

The information submitted by customer 301, if correct, may mitigate a risk that the transaction may incur a post-authorization charge. The information requested from customer 301 may include information for verifying a relationship between customer 301 and the payment instrument presented by customer 301 to initiate the transaction.

At step 12, customer 301 provides information responsive to the selected authorization method to merchant 303. At step 13, merchant 303 routes the responsive information to acquirer 305. At step 14, acquirer 305 routes the responsive information to transaction processing network 307. At step 15, transaction processing network 307 routes the responsive information to issuer 309. At step 16, issuer 309 submits the responsive information to AMS 311. AMS 311 may validate the responsive information entered by customer 301. The responsive information may be validated by comparing the response of customer 301 to previously stored data associated with a presented payment instrument.

In some embodiments, issuer 309 or another transaction participant may validate the information entered by customer 301. In some embodiments, the information may not be validated prior to issuer 309 authorizing the transaction. In some embodiments, to obtain a payment guarantee for the transaction, merchant 303 may be required to submit the information entered by customer 301 to issuer 309 within a pre-determined timeframe. The pre-determined timeframe may be 24 hours from a time the transaction is initiated by customer 401 or any suitable timeframe.

At step 17, AMS 311 informs issuer 309 of a result of validating the information received from customer 401. At step 18, if AMS 311 validates the responsive information, issuer 309 transmits an authorization for the transaction to transaction processing network 307. In some embodiments, if AMS 311 is unable to validate the responsive information, at step 18, issuer 309 may transmit a denial of the transaction.

At step 19, transaction processing network 407 routes the authorization to acquirer 305. At step 20, in response to receiving the authorization, merchant 303 releases goods to customer 301. At step 21, acquirer 305 transfers payment for the goods to merchant 303.

In embodiments that include communication lines 413, merchant 303 may communicate directly with AMS 311. In embodiments that include communication lines 415, transaction processing network 307 may communicate directly with AMS 311. In embodiments that include communication lines 417, acquirer 305 may communicate directly with AMS 311.

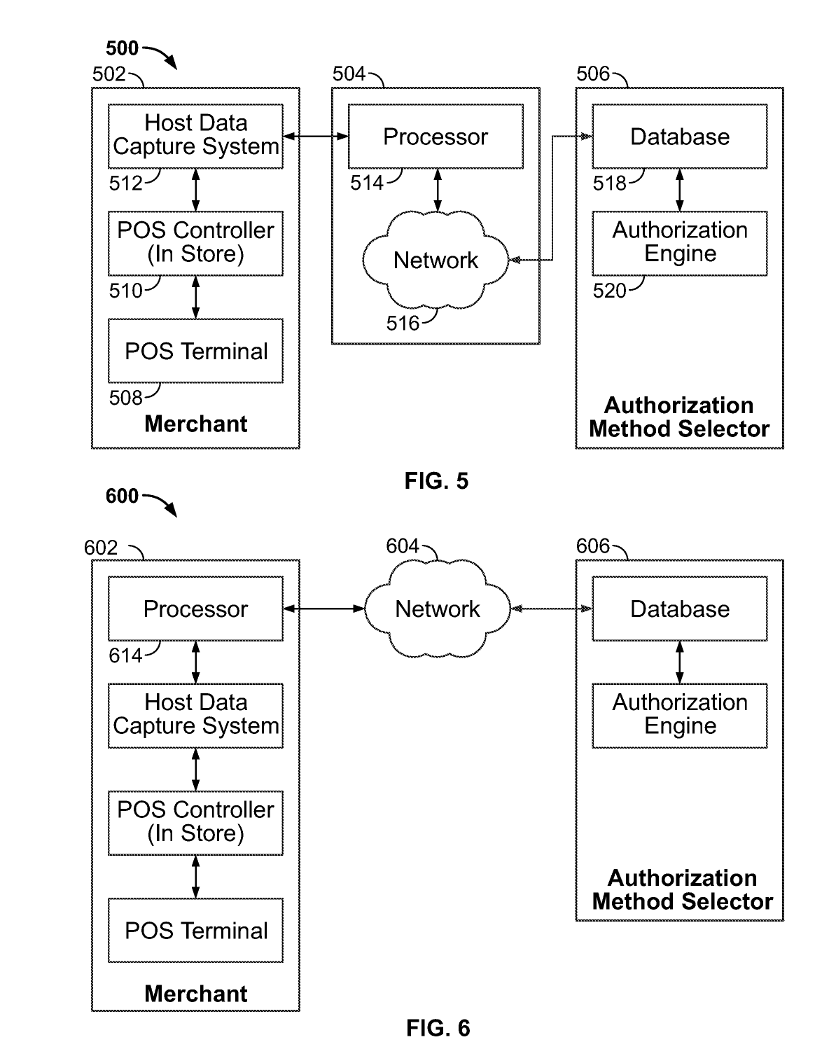

FIG. 5 shows illustrative system 500 for processing and communicating transaction information. Transaction information may include transaction records, authorization methods, authorization responses, information responsive to a selected authorization method or any suitable information.

System 500 may include merchant component 502, network component 504 and authorization method selection (“AMS”) component 506. In some embodiments, AMS component 506 may be operated by transaction participant such as an issuer. In general, a system such as 500 may include many merchant components such as 502, many AMS components such as 506 and many network components such as 504.

A customer may purchase goods by transferring payment instrument information from a personal data storage device, such as a credit card, debit card or smartphone, to POS terminal 508. POS terminal 508 may read customer information from a payment instrument. The payment instrument may store data in a magnetic strip, a bar code, a silicon chip or any other suitable data storage device or format.

The payment instrument information may include issuer information, account information and any other suitable information. Illustrative payment instrument information is shown above in table 3.

POS terminal 508 may transmit transaction information to POS controller 510. The transaction information may include some or all of the payment instrument information and any other suitable information, such as the transaction amount, information regarding the purchased goods or other transaction attributes.

POS controller 510 may act as a server for providing user prompts and display layout information to one or more POS terminals such as POS terminal 508. POS controller 510 may receive transaction information from one or more of the POS terminals.

POS controller 510 may transmit the transaction information to host data capture system 512. Host data capture system 512 may store transaction information from POS controller 510. Host data capture system 512 may store accounting data, SKU data, location, time/date and other suitable data that may be included in a transaction record.

The transaction information may include merchant information. The merchant information may include information about the merchant, the merchant's business, the merchant's network membership, the merchant's business behavior and any other suitable information. The merchant information may be included in a transaction record.

Transaction information may include some or all of the information that is necessary to select an authorization method for a transaction. The selected authorization method may depend on interchange rates, network-fee rates, merchant type, merchant size, transaction processing method, and any other suitable transaction attributes.

The transaction information may be stored in any suitable element of merchant component 502, network component 504 and issuer component 506. For example, transaction information may be stored in processor 514. Processor 514 may include algorithms that may be used in conjunction with the transaction information to identify and quantify a risk that a transaction, corresponding to the customer transaction taking place at POS terminal 508, may incur a post-authorization charge. Processor 514 may include algorithms that may be used in conjunction with the transaction information to identify an authorization method for a transaction initiated at POS terminal 508.

Host data capture system 512 may create a transaction record based on the transaction information. The transaction record may include some or all of the transaction information. The transaction information may include one or more transaction attributes. Illustrative transaction attributes are shown above in table 5.

POS terminal 508 may have one or more interactive features that a customer may use. The features may provide the customer with instructions that may help the customer enter information responsive to a selected authorization method transmitted to merchant component 502. For example, POS terminal 508 may display a prompt requesting that the customer enter one or more the verification information shown above in table 6.

Host data capture system 512 may route the transaction record to processor 514. Processor 514 may include a credit card network “processor,” which is known to those of ordinary skill in the art. The illustrative systems shown in FIGS. 5 and 6 may include one or more other processors that perform tasks that are appropriate for the components thereof.

Processor 514 may route the transaction record, via network 516, to database 518. The routing may be governed by the transaction information. For example, the routing may be governed by a bank issuer number (“BIN”) that is encoded in the customer's payment instrument. Authorization engine 520 may select an authorization method based on the transaction information. The authorization method may include requesting that the customer provide additional information. The additional information may mitigate a risk of the transaction incurring a post-authorization charge.

Authorization engine 520 may transmit authorization information back to POS terminal 508 through network 516, processor 514, host data capture system 512 and POS controller 510. The authorization information may include the authorization method and/or decision. The transaction information may be used by processor 514 to route the authorization information back to the merchant and the POS terminal where the customer is present.

FIG. 6 shows illustrative system 600 for processing and communicating transaction information. System 600 may include merchant component 602, network component 604 and AMS component 606. In general, a system such as 600 may include many merchant components such as 602 and many AMS components such as 606. System 600 may have one or more of the features that are described herein in connection with system 600 (shown in FIG. 6).

In system 600, processor 614 may be present in merchant component 602. Corresponding processor 614 is present in network component 604 (shown in FIG. 6). Systems such as 600 are designed for merchants that require high throughput of merchant information and transaction information. Systems such as 700 are designed for merchants that do not require high throughput of merchant information and transaction fee information.

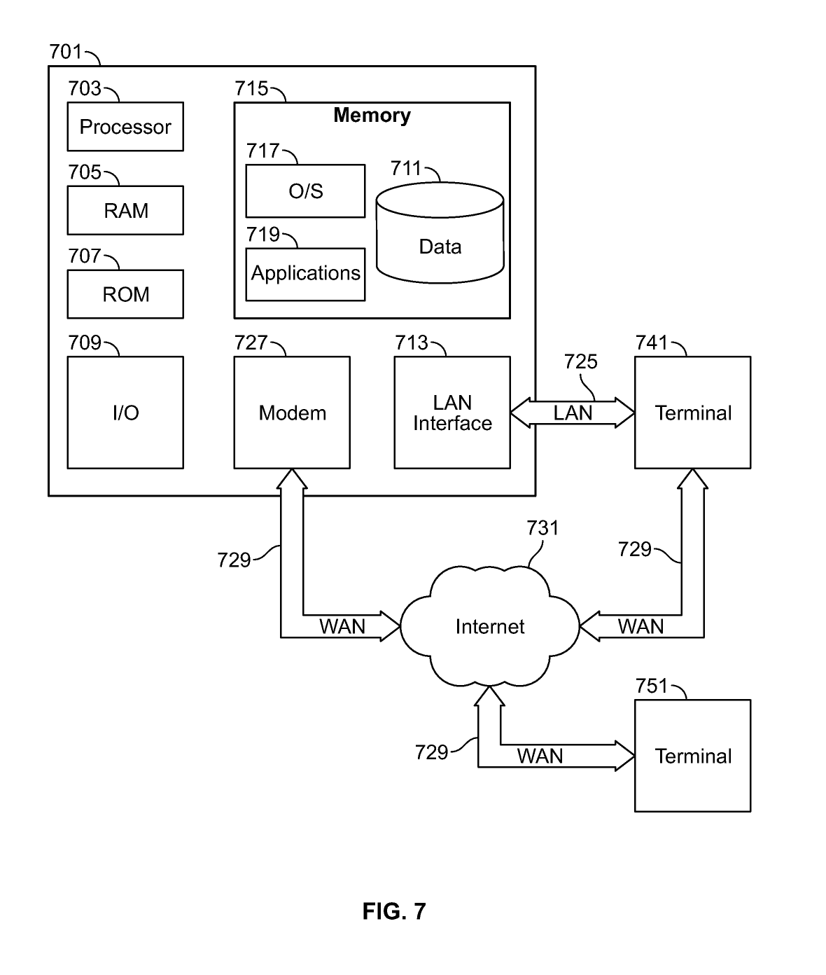

FIG. 7 is a block diagram that illustrates a computing device 701 (alternatively referred to herein as a “server or computer”) that may be used according to an illustrative embodiment of the invention. The computer server 701 may have a processor 703 for controlling overall operation of the server and its associated components, including RAM 705, ROM 707, input/output (“I/O”) module 709, and memory 715.

I/O module 709 may include a microphone, keypad, touch screen and/or stylus through which a user of device 701 may provide input, and may also include one or more of a speaker for providing audio output and a video display device for providing textual, audiovisual and/or graphical output. Software may be stored within memory 715 and/or other storage (not shown) to provide instructions to processor 703 for enabling server 701 to perform various functions. For example, memory 715 may store software used by server 701, such as an operating system 717, application programs 719, and an associated database 711. Alternatively, some or all of computer executable instructions of server 701 may be embodied in hardware or firmware (not shown).

Server 701 may operate in a networked environment supporting connections to one or more remote computers, such as terminals 741 and 751. Terminals 741 and 751 may be personal computers or servers that include many or all of the elements described above relative to server 701. The network connections depicted in FIG. 7 include a local area network (LAN) 725 and a wide area network (WAN) 729, but may also include other networks. When used in a LAN networking environment, computer 701 is connected to LAN 725 through a network interface or adapter 713. When used in a WAN networking environment, server 701 may include a modem 727 or other means for establishing communications over WAN 729, such as Internet 731.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 719, which may be used by server 701, may include computer executable instructions for invoking user functionality related to communication, such as email, short message service (SMS), and voice input and speech recognition applications.

Computing device 701 and/or terminals 741 or 751 may also be mobile terminals including various other components, such as a battery, speaker, and antennas (not shown). Terminal 751 and/or terminal 741 may be portable devices such as a laptop, tablet, smartphone or any other suitable device for receiving, storing, transmitting and/or displaying relevant information.

Any information described above in connection with database 711, and any other suitable information, may be stored in memory 715. One or more of applications 719 may include one or more algorithms that may be used to evaluate transaction risk, communicate transaction information, determine authorization methods, evaluate information responsive to a selected authorization method and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

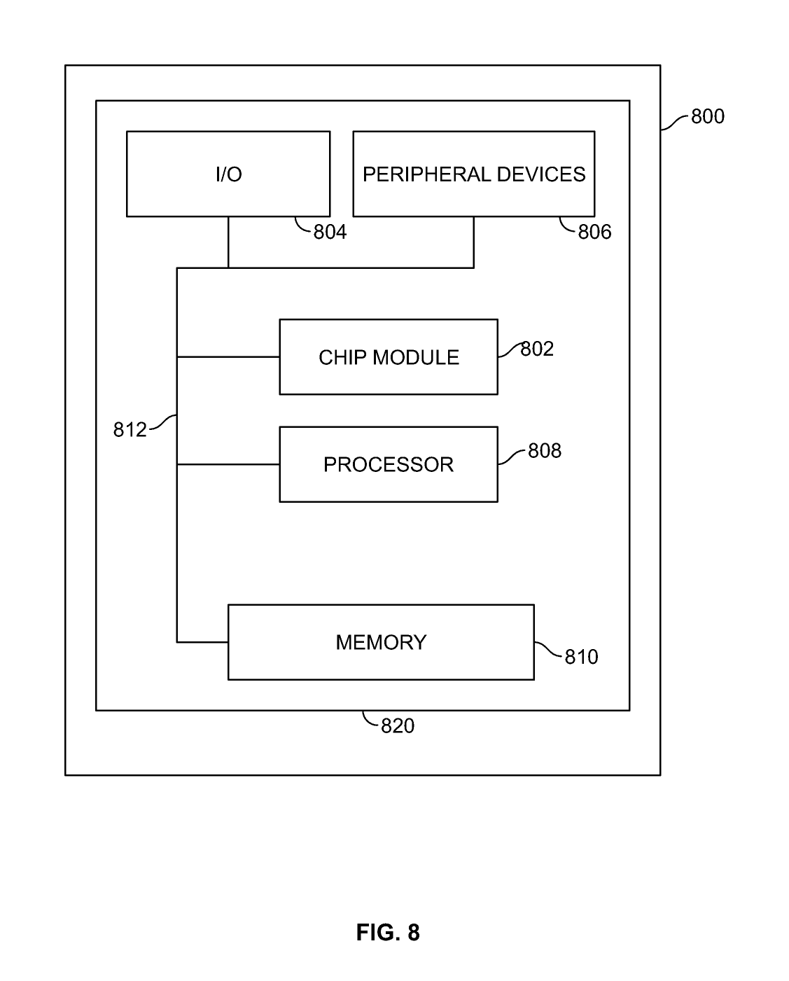

FIG. 8 shows illustrative apparatus 800. Apparatus 800 may be a computing machine. Apparatus 800 may include one or more features of the apparatus shown in FIG. 7. Apparatus 800 may include chip module 802, which may include one or more integrated circuits, and which may include logic configured to perform any other suitable logical operations.

Apparatus 800 may include one or more of the following components: I/O circuitry 804, which may include a transmitter device and a receiver device and may interface with fiber optic cable, coaxial cable, telephone lines, wireless devices, PHY layer hardware, a keypad/display control device or any other suitable encoded media or devices; peripheral devices 806, which may include counter timers, real-time timers, power-on reset generators or any other suitable peripheral devices; logical processing device 808, which may compute data structural information, structural parameters of the data, quantify indices; and machine-readable memory 810.

Machine-readable memory 810 may be configured to store in machine-readable data structures: exception reports, rules tables, lexical items tables, computer code and any other suitable information or data structures.

Components 802, 804, 806, 808 and 810 may be coupled together by a system bus or other interconnections 812 and may be present on one or more circuit boards such as 820. In some embodiments, the components may be integrated into a single chip. The chip may be silicon-based.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, tablets, programmable consumer electronics, network PCs, minicomputers, mainframe computers, distributed computing environments that include any of the above systems or devices, and the like. In a distributed computing environment, devices that perform the same or similar function may be viewed as being part of a “module” even if the devices are separate (whether local or remote) from each other.

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network. In a distributed computing environment, program modules may be located in both local and remote computer storage media including memory storage devices.

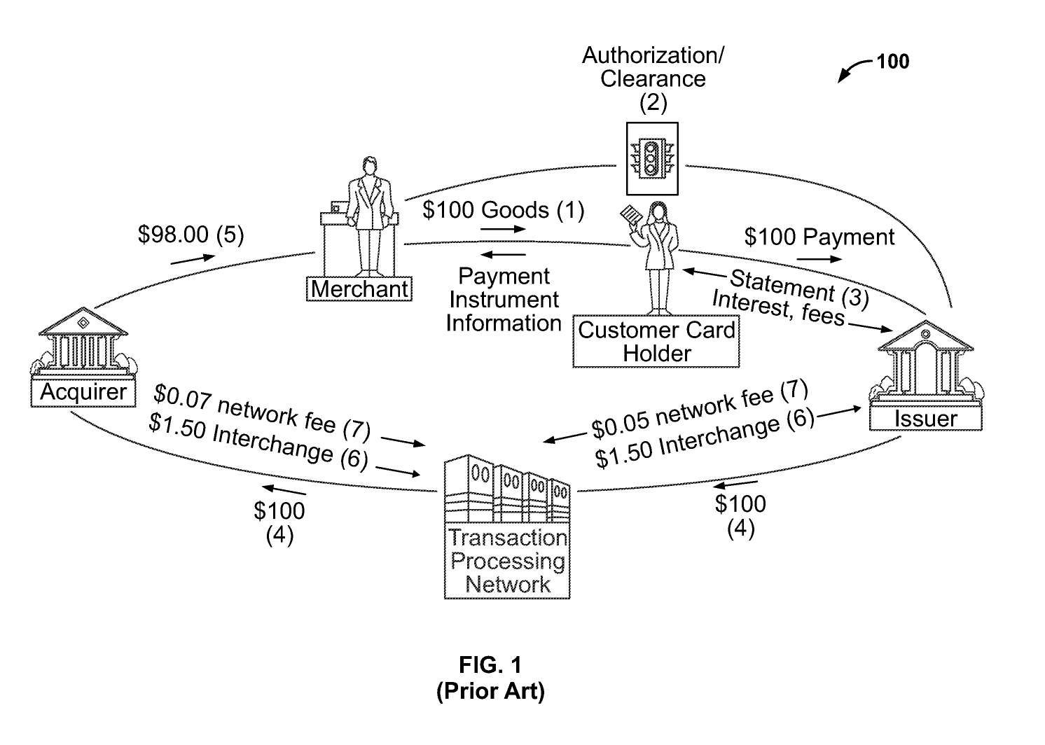

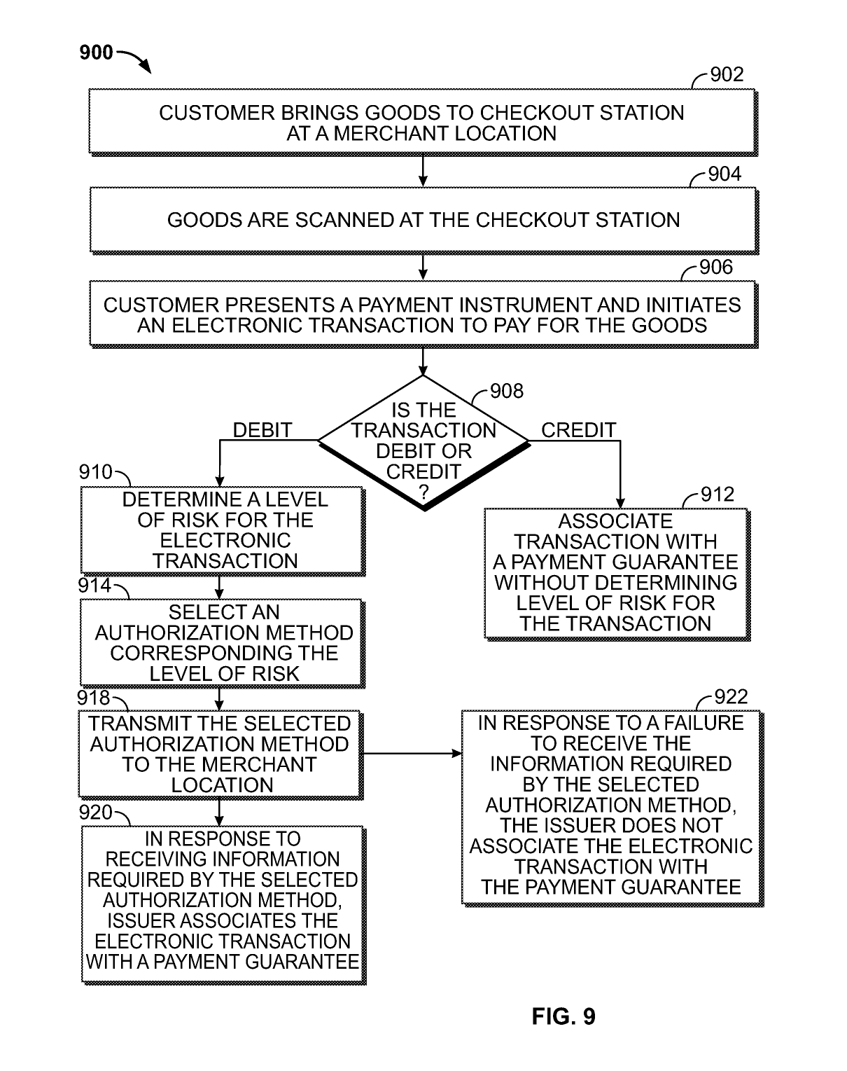

FIG. 9 shows illustrative process 900. For the sake of illustration, one or more of the steps of the process illustrated in FIG. 9 will be described as being performed by a “system.” The “system” may include one or more of the features of the apparatus, arrangements information or processes shown in FIGS. 1-8 and/or any other suitable device or approach. The “system” may be provided by an entity. The entity may be an individual, an organization, a transaction participant or any other suitable provider.

Process 900 begins at step 902. At step 902, a customer brings goods to a checkout station at a merchant location. At step 904, the system scans the goods at the checkout station. At step 906, the customer presents a payment instrument and initiates an electronic transaction to pay for the goods.

At step 908 the system identifies whether the electronic transaction is a debit transaction or a credit transaction. The system may be configured to identify any suitable class or type of electronic transaction.

When the system identifies an electronic debit transaction, at step 910, the system determines a level of risk associated with the electronic debit transaction. The level of risk may include a risk that the electronic debit transaction may incur a post-authorization charge. At step 914, the system selects an authorization method corresponding to the level of risk. The greater the risk, the more information may be requested by the selected authorization method.

At step 918, the system transmits the selected authorization method to the merchant location. The selected authorization method may be presented to the customer at the point-of-sale via a POS terminal. The customer may enter information responsive to the selected authorization method via the POS terminal.

At step 920, in response to receiving information required by the selected authorization method, an issuer of the payment instrument associates the electronic debit transaction with a payment guarantee. The payment guarantee may absolve the merchant or other transaction participant from liability associated with a post-authorization charge.

At step 922, if the system does not receive information required by the selected authorization method, the issuer does not associate the electronic transaction with the payment guarantee. Without the payment guarantee, a merchant, customer or other transaction participant may be liable for a post-authorization charge associated with the transaction.

If at step 908 the system identifies a transaction as an electronic credit transaction, the system may associate transaction with a payment guarantee without determining level of risk for the transaction. An interchange or other processing fee associated with a credit transaction may allow an issuer to bear full responsibility for a post-authorization charge associated with the transaction.

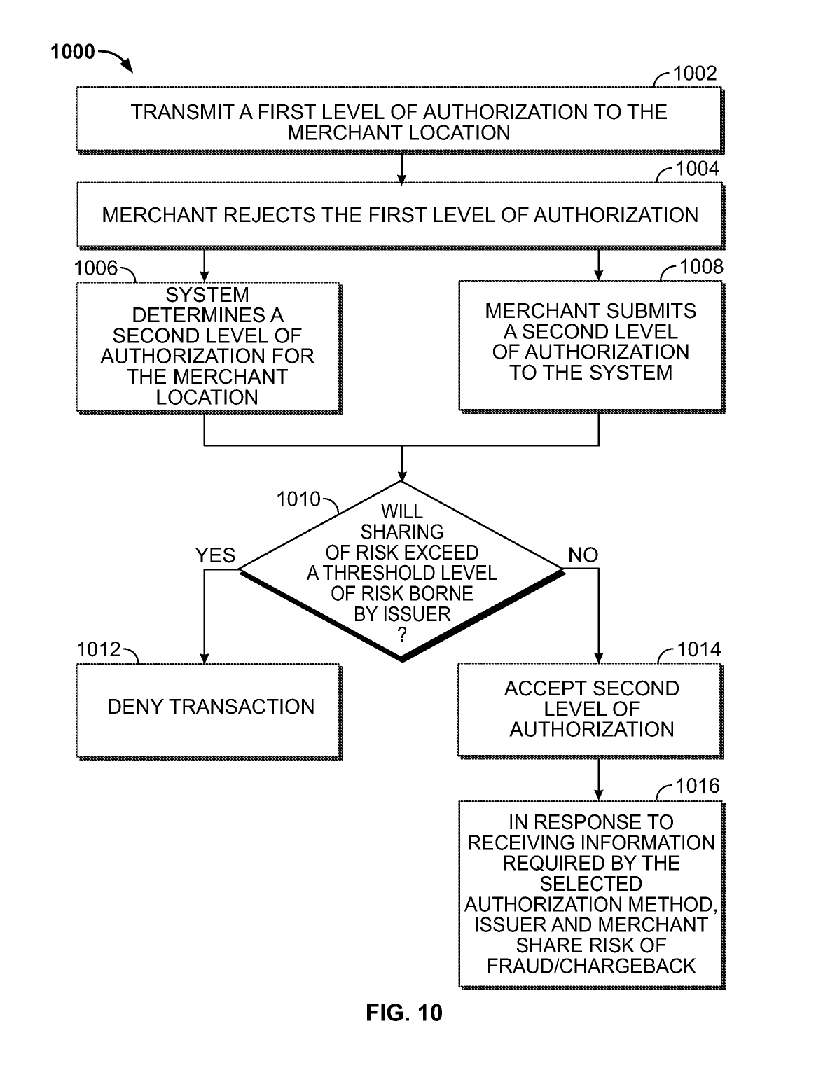

FIG. 10 shows illustrative process 1000. For the sake of illustration, one or more of the steps of the process illustrated in FIG. 10 will be described as being performed by a “system.” The “system” may include one or more of the features of the apparatus, arrangements information or processes shown in FIGS. 1-9 and/or any other suitable device or approach. The “system” may be provided by an entity. The entity may be an individual, an organization, a transaction participant or any other suitable provider.

Process 1000 begins at step 1002. At step 1002, the system transmits a first level of authorization to the merchant location. The first level of authorization may be an authorization method selected based on one or more transaction attributes. At step 1004, the merchant rejects the first level of authorization. The merchant may feel that the first level of authorization is too burdensome to impose on a customer.

At step 1006, in response to the rejection, system determines a second level of authorization for the merchant location. The second level of authorization may correspond to an authorization method may is less burdensome on the customer than the first level of authorization. At step 1008, the merchant submits a second level of authorization to the system. The merchant may submit an authorization method that the merchant feels comfortable imposing on the customer.

The second level of authorization, by relaxing the requirements of the first level of authorization, may expose an issuer to a greater level of transaction risk. At step 1010, the system determines risk exposure associated with the second level of authorization exceeds a threshold level of risk borne by a transaction participant such as an issuer.

At step 1012, if the issuer's risk exposure associated with the second level of authorization is above the threshold, the issuer denies the transaction. Based on the risk exposure associated with the transaction, the issuer may not wish to participant in the transaction or share any risk associated with the transaction.

At step 1014, if the issuer's risk exposure associated with the second level of authorization is below the threshold, the issuer may accept the second level of authorization. At step 1016, in response to receiving information required by the selected authorization method, issuer and merchant may share the risk exposure associated with the transaction. The risk exposure may include a risk of fraud/chargeback charges. In some embodiments, a single transaction participant may agree to bear the entire risk when a risk exposure associated with the second level of authorization is below a threshold.

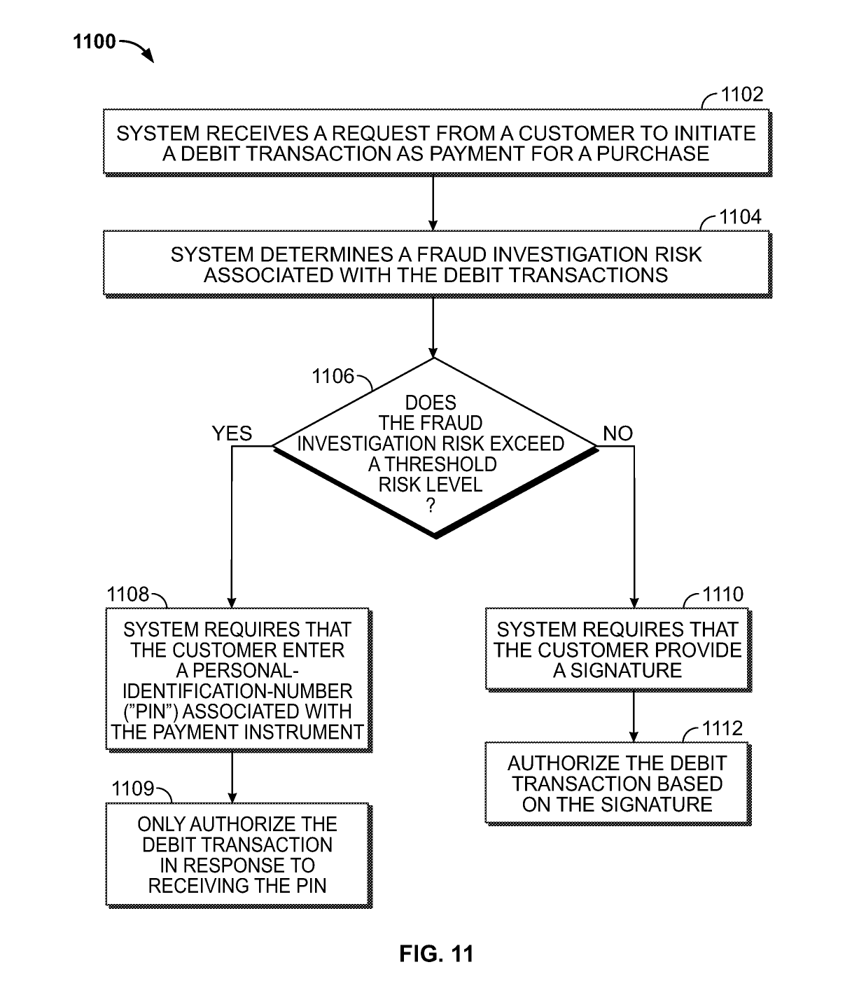

FIG. 11 shows illustrative process 1100. For the sake of illustration, one or more of the steps of the process illustrated in FIG. 11 will be described as being performed by a “system.” The “system” may include one or more of the features of the apparatus, arrangements information or processes shown in FIGS. 1-10 and/or any other suitable device or approach. The “system” may be provided by an entity. The entity may be an individual, an organization, a transaction participant or any other suitable provider.

Process 1100 begins at step 1102. At step 1102, the system receives a request from a customer to initiate a debit transaction as payment for a purchase. At step 1104, the system determines a fraud investigation risk associated with the debit transactions. The fraud investigation risk may include a risk that a transaction participant receives a claim alleging that the transaction was fraudulently initiated. The claim may require the transaction participant to incur costs to investigate the claim.

At step 1106, the system may determine whether the transaction is associated with a fraud investigation risk that exceeds a threshold risk level. At step 1108, if the fraud investigation risk exceeds the threshold, the system requires that the customer enter a personal-identification-number (“PIN”) associated with the payment instrument. At step 1109, the system only authorizes the debit transaction in response to receiving the PIN.

At step 1110, if the system determines that the fraud investigation does not exceed the threshold risk level, the system requires that the customer provide a signature. At step 1112, the system authorizes the debit transaction based on the signature.

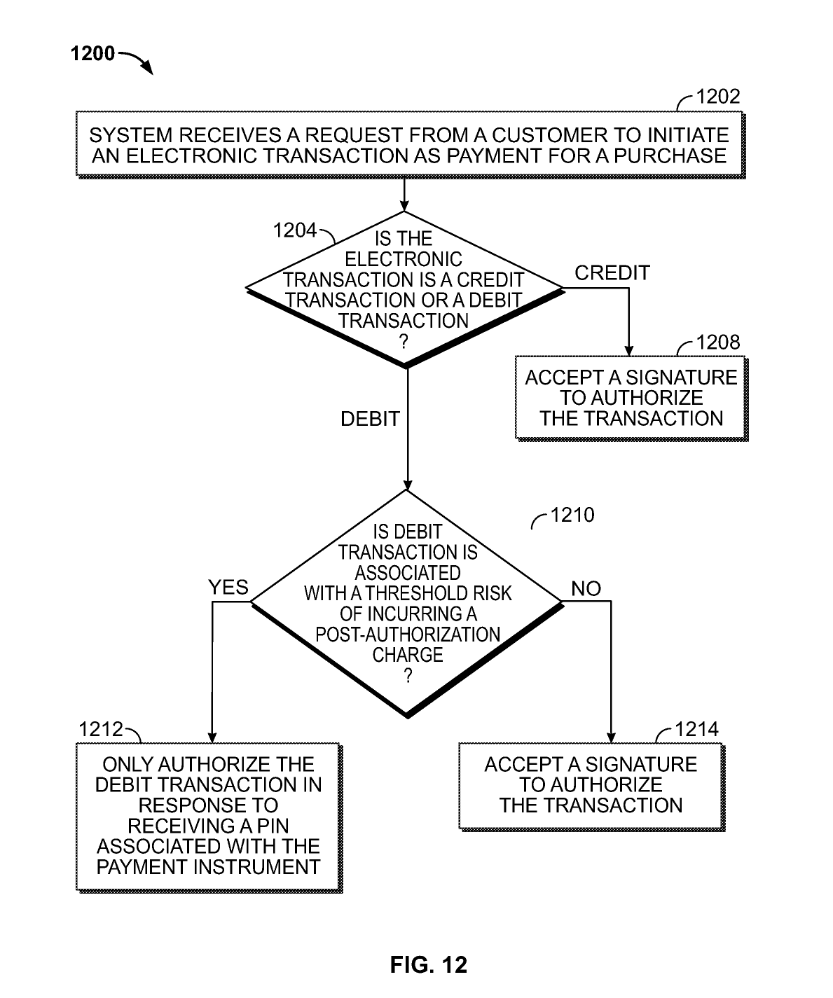

FIG. 12 shows illustrative process 1200. For the sake of illustration, one or more of the steps of the process illustrated in FIG. 12 will be described as being performed by a “system.” The “system” may include one or more of the features of the apparatus, arrangements information or processes shown in FIGS. 1-11 and/or any other suitable device or approach. The “system” may be provided by an entity. The entity may be an individual, an organization, a transaction participant or any other suitable provider.

Process 1200 begins at step 1202. At step 1202, the system receives a request from a customer to initiate an electronic transaction as payment for a purchase. At step 1204, the system determines whether the electronic transaction is a credit transaction or a debit transaction.

At step 1210, when system determines that the transaction is debit transaction, the system evaluates whether the debit transaction is associated with a threshold risk of incurring a post-authorization cost. At step 1212, if the debit transaction is associated with a threshold risk level, the system only authorizes the debit transaction in response to receiving a PIN associated with the payment instrument. At step 1214, if the debit transaction is not associated with a threshold risk level, the system accepts a signature to authorize the transaction.

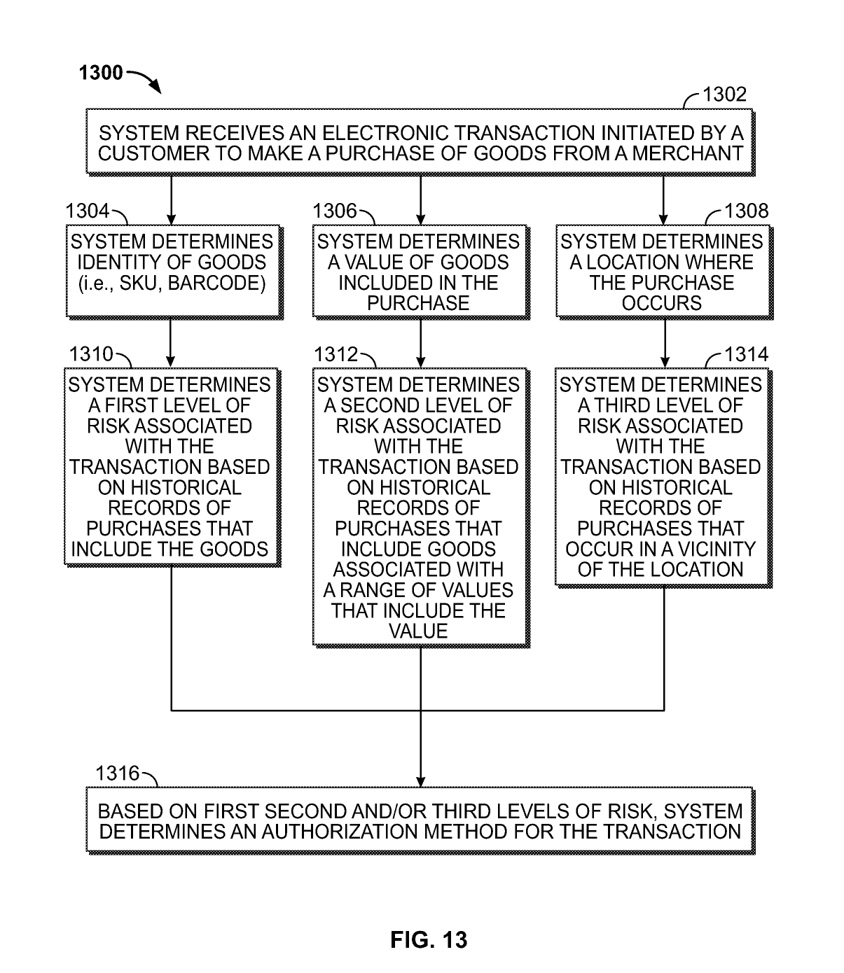

FIG. 13 shows illustrative process 1300. For the sake of illustration, one or more of the steps of the process illustrated in FIG. 13 will be described as being performed by a “system.” The “system” may include one or more of the features of the apparatus, arrangements information or processes shown in FIGS. 1-12 and/or any other suitable device or approach. The “system” may be provided by an entity. The entity may be an individual, an organization, a transaction participant or any other suitable provider.

Process 1300 begins at step 1302. At step 1302, the system receives an electronic transaction initiated by a customer to make a purchase of goods from a merchant.

At step 1304, the system determines an identity of goods (i.e., SKU, barcode) included in the purchase. At step 1310, the system determines a first level of risk associated with the transaction based on historical records of purchases that include the goods.

An analysis of the historical records may indicate that goods included in the purchase are associated with a threshold number of post-authorization charges. An analysis of the historical records may indicate that goods included in the purchase are associated with a threshold monetary value of post-authorization charges.

At step 1306, the system determines a value of goods included in the purchase. At step 1312, the system determines a second level of risk associated with the transaction based of historical records of purchases that include goods associated the value. The system may determine the second level of risk based on an analysis of historical records of purchase that include a range of values.

The value of the purchase may appear to be unusual for a customer. An unusual value may be a large value. The unusual value may be a small value. For example, the value of the purchase may be compared to values in historical transaction records. The method may include determining that the value appears to be “excessive” past on the customer's transaction history.

An analysis of the historical records may indicate that goods associated with the value are associated with a threshold number of post-authorization charges. More expensive items may be targeted by an individual that initiates a fraudulent transaction. An analysis of the historical records may indicate that goods included in the purchase are associated with a threshold monetary value of post-authorization charges (i.e., fraud).

At step 1308, the system determines a location where the purchase occurs. At step 1314, the system determines a third level of risk associated with the transaction based of historical records of purchases that occur in a vicinity of the location.

An analysis of the historical records may indicate that a location is associated with a threshold number of post-authorization charges. A location may be known for its lax oversight vetting fraudulent transactions. The location may be a common target of an individual that initiates a fraudulent transaction. An analysis of the historical records may indicate that purchases conducted at the location are associated with a threshold monetary value of post-authorization charges (i.e., fraud).

At step 1316, based on the first second and/or third levels of risk, the system determines an authorization method for the transaction.

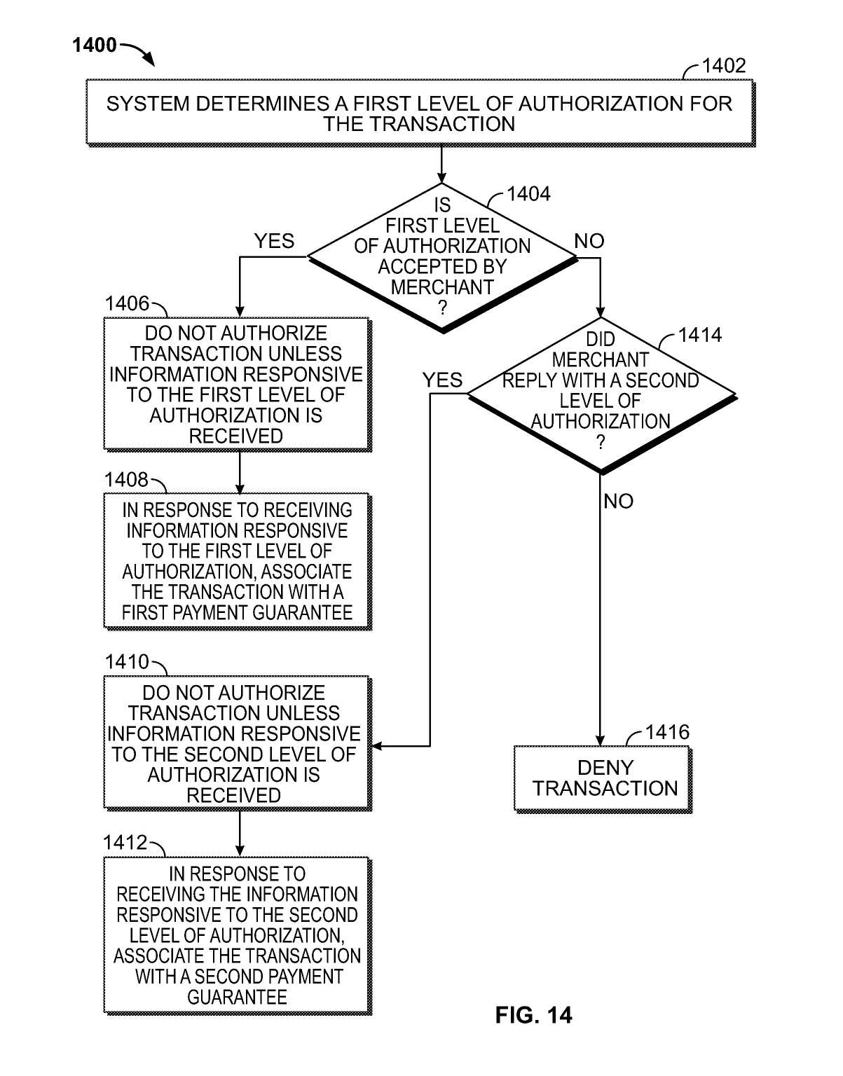

FIG. 14 shows illustrative process 1400. For the sake of illustration, one or more of the steps of the process illustrated in FIG. 14 will be described as being performed by a “system.” The “system” may include one or more of the features of the apparatus, arrangements information or processes shown in FIGS. 1-13 and/or any other suitable device or approach. The “system” may be provided by an entity. The entity may be an individual, an organization, a transaction participant or any other suitable provider.

Process 1400 begins at step 1402. At step 1402, the system determines a first level of authorization for the transaction. At step 1404, the system determines whether the first level of authorization accepted by merchant. The merchant may accept the first level of authorization by agreeing to obtain information responsive to the level of authorization.

If the merchant accepts the first level of authorization, at step 1406, the system does not authorize transaction unless information responsive to the first level of authorization is received by the system. At step 1408, in response to receiving information responsive to the first level of authorization, the system associates the transaction with a first payment guarantee. The first payment guarantee may immunize the merchant from an effect of a post-authorization charge associated with the transaction. The information responsive to the first level of authorization may reduce a risk of the transaction incurring the post-authorization charge.

At step 1414, when the merchant does not accepts the first level of authorization, the system may determine whether the merchant responded with a second level of authorization. The second level of authorization may require less information than the first level. At step 1410, if the merchant responded with the second level of authorization, the system does not authorize transaction unless information responsive to the second level of authorization is received.

At step 1412, in response to receiving the information responsive to the second level of authorization, the system associates the transaction with a second payment guarantee. The second payment guarantee may partially immunize the merchant from an effect of a post-authorization charge associated with the transaction. For example, the merchant may be responsible for at least a portion of a post-authorization charge, or may be required to refund a portion of the purchase amount.

At step 1416, when the merchant does not accept the first level of authorization and does not submit a second, alternative level of authorization, the system denies the transaction. A transaction participant operating the system may deny the transaction as a result of the risk level associated with the transaction exceeding the threshold risk. The transaction participant may decline to participate in the transaction as a result of the risk level associated with the transaction.

One of ordinary skill in the art will appreciate that the steps shown and described herein may be performed in other than the recited order and that one or more steps illustrated may be optional. The methods of the above-referenced embodiments may involve the use of any combination of methods, portions of methods, partially executed methods, elements, one or more steps, computer-executable instructions, or computer-readable data structures disclosed herein. In this regard, other embodiments are disclosed herein as well that can be partially or wholly implemented on a computer-readable medium, for example, by storing computer-executable instructions or modules or by utilizing computer-readable data structures.

Thus, systems and methods for risk mitigating transaction authorization have been provided. Persons skilled in the art will appreciate that the present invention can be practiced by other than the described embodiments, which are presented for purposes of illustration rather than of limitation. The present invention is limited only by the claims that follow.

What is claimed is:

1. A computer that is configured to dynamically select an authorization method for a debit transaction initiated by a customer at a point-of-sale using a payment instrument, the computer comprising:
a non-transitory computer readable medium having computer readable program code embodied therein; and
a processor configured to execute the computer readable program code;
the computer readable program code when executed by the processor:
requests a stock-keeping-unit (“SKU”) of an item captured by a scanner at the point-of-sale;
identifies the payment instrument as a debit card;
determines, based on the SKU, a level of risk associated with the debit transaction;
selects an authorization method based on the level of risk;
transmits the selected authorization method to the point-of-sale;
in response to receiving information required by the selected authorization method, associates the debit transaction with a payment guarantee provided by an issuer of the payment instrument; and
in response to a failure to receive the information required by the selected authorization method, does not associate the debit transaction with the payment guarantee.

2. The computer of claim 1, the selected authorization method comprising computer readable program code that when executed by the processor:
requires the customer to enter a personal-identification-number linked to the payment instrument to authorize the debit transaction; and
does not allow the customer to sign at the point-of-sale to authorize the debit transaction.

3. The computer of claim 1, the selected authorization method comprising computer readable program code that when executed by the processor requires verification of a relationship between the customer and the payment instrument.

4. The computer of claim 3, the computer readable program code when executed by the processor requires that the verification comprise:
transmitting, to the issuer of the payment instrument, of a zip code entered by the customer at the point-of-sale; and
determining whether the zip code is associated with the payment instrument.

5. The computer of claim 1, the selected authorization method comprising computer readable program code that when executed by the processor requires verification of a characteristic of the payment instrument.

6. The computer of claim 5, the computer readable program code when executed by the processor requires that the verification comprise:
transmitting, to the issuer of the payment instrument from the point-of-sale, information displayed on the payment instrument; and
determining whether the information is associated with the payment instrument.

7. The computer of claim 1, the computer readable program code when executed by the processor, in response to a rejection of the selected authorization method, denies the debit transaction.

8. The computer of claim 1, wherein, when the selected authorization method is a first selected authorization method, the computer readable program code when executed by the processor in response to a rejection of the first selected authorization method:
selects a second authorization method based on the level of risk; and
transmits the second selected authorization method to the point-of-sale.

9. The computer of claim 8, wherein when the payment guarantee is a first payment guarantee, the computer readable program code when executed by the processor, in response to receiving information required by the second selected authorization method, associates a second payment guarantee of the issuer with the debit transaction;
wherein an amount guaranteed by the second payment guarantee is less than an amount of the debit transaction.

10. The computer of claim 1, the selected authorization method comprising computer readable program code that when executed by the processor requires:
capturing, at the point-of-sale, a barcode displayed on a photo identification of the customer; and
transmitting the barcode from the point-of-sale to the issuer of the payment instrument.

11. The computer of claim 1, the selected authorization method comprising computer readable program code that when executed by the processor requires transmitting, from the point-of-sale to the issuer, confirmation that a name displayed on a photo identification of the customer corresponds to a name displayed on the payment instrument.

12. The computer of claim 1 the computer readable program code when executed by the processor:
receives a proposed change to the selected authorization method transmitted to the issuer; and
does not register the proposed change as the failure to receive the information required by the selected authorization method.

13. The computer of claim 12 the computer readable program code when executed by the processor denies the debit transaction when, for a plurality of debit transactions, the proposed change increases an aggregate dollar amount of risk, associated with the SKU and accepted by the issuer, above a threshold dollar amount.

14. The computer of claim 13, wherein the aggregate dollar amount of risk comprises risk that the issuer will receive a threshold number of claims alleging that the threshold number of the plurality of debit transactions associated with the SKU are fraudulent.

15. The computer of claim 13, wherein the aggregate dollar amount of risk comprises a cost of chargebacks submitted to the issuer for the plurality of debit transactions associated with the SKU.

16. One or more non-transitory computer-readable media storing computer-executable instructions which, when executed by a processor on a computer system, perform a method of dynamically selecting an authorization method for a debit transaction, the method comprising:
receiving a request from a customer to initiate the debit transaction as payment for a purchase;
determining a fraud investigation risk corresponding to the debit transaction;
in response to determining that the fraud investigation risk exceeds a threshold risk level:
requiring that the customer enter a personal-identification-number (“PIN”) associated with the payment instrument;
only authorizing the debit transaction based on the PIN; and
in response to determining that the fraud investigation risk does not exceed the threshold risk level:
requiring that the customer provide a signature; and
authorizing the debit transaction based on the signature.

17. The computer-readable media of claim 16, wherein the method is performed within one second from a time the debit transaction is initiated.

18. The computer-readable media of claim 16, the method further comprising, in response to determining that the risk exceeds the threshold risk level, denying the transaction if the PIN is not received.

19. The computer-readable media of claim 16, wherein in the method, the fraud investigation risk comprises a risk of receiving a chargeback of the debit transaction.

20. The computer-readable media of claim 16, wherein when the purchase is a first purchase and the customer a first customer, the method further comprising:
receiving a request from a second customer to initiate a credit transaction as payment for a second purchase;
requiring that the second customer provide a signature; and
authorizing the credit transaction based on the signature without determining the fraud investigation risk corresponding to the credit transaction.

21. An article of manufacture comprising a computer usable medium having computer readable program code embodied therein, the code when executed by a processor authorizes a transaction initiated using a payment instrument, the computer readable program code in said article of manufacture when executed by the processor:
determines whether the transaction is a credit transaction or a debit transaction;
when the transaction is the debit transaction:
determines whether the debit transaction is associated with a threshold risk of incurring a post-authorization cost; and
when the debit transaction is associated with the threshold risk, only authorizes the debit transaction in response to receiving a personal-identification-number associated with the payment instrument;
when the transaction is the credit transaction, authorizes the credit transaction in response to receiving:
a personal-identification-number associated with the payment instrument; or
a signature.

22. The article of claim 21 the computer readable program code in said article of manufacture when executed by the processor denies the debit transaction in response to a failure to receive the personal-identification-number.
